(19) United States
(12) Patent Application Publication
(10) Pub. No.: US 2014/0372328 A1
(43) Pub. Date: Dec. 18, 2014

(54) METHODS AND APPARATUS HAVING APPLICABILITY TO SUCCESSION PLANNING

(71) Applicant: Saba Software, Inc., Redwood Shores, CA (US)

(72) Inventors: Bernard P. Willis, San Francisco, CA (US); Hemanth Puttaswamy, Fremont, CA (US)

(21) Appl. No.: 13/917,632

(22) Filed: Jun. 13, 2013

(51) Int. Cl. G06Q 50/00; G06Q 10/10

(52) U.S. Cl. CPC G06Q 50/01; G06Q 10/105
USPC 705/319

(57) ABSTRACT

Techniques having applicability to succession planning may include providing an option, in a computer-implemented professional networking platform, for a first member of a professional community to designate a second member of the professional community as deserving of promotion. In response to the designation, a nomination may be received from the first member, via the computer-implemented professional networking platform, of a third member of the professional community as a potential successor for the second member. Further techniques may include receiving, from an employee, information about the employee's professional characteristics, and presenting the information to human resources (HR) personnel. One or more automated similarity algorithms may be applied to identify, based on the information about the employee's professional characteristics, information likely to be of interest to the employee, which may be provided to the employee in return for the information about the employee's professional characteristics.

### BACKGROUND

Employers who hire significant numbers of employees typically require a system of some sort to manage those employees. Often this service is performed by a Human Resources (HR) department of the employer entity or organization, which is charged with ensuring that the employer is sufficiently staffed to efficiently conduct its business on a day-to-day basis. This may involve hiring and training employees, establishing and disbursing appropriate compensation and benefits, implementing programs directed toward employee retention, conducting performance reviews, monitoring employee absences and withdrawals, and/or terminating employees as necessary, among other possible functions. Typically these HR tasks are performed by a staff of HR personnel (themselves employees) who bring their human experience and training to bear on monitoring employees and taking necessary actions to ensure that the employer is efficiently and consistently staffed.

As used herein, the term “employee” refers to a (human) person working for an employer for some form of compensation, and includes temporary or project-based workers such as independent contractors in addition to more traditional types of employees. The term “employer” refers to an entity or organization that hires employees to do at least some of its work, and includes for-profit business enterprises, non-profit organizations, and government entities, among others. The term “human resources (HR) personnel” refers to employees tasked with managing an employer's overall workforce or a generalized subset of the employer's workforce (such as, for example, all the employer's employees in a particular geographic location), as distinct from managing only particular individual employees. The term “manager” refers to an employee having supervisory authority over one or more other employees. Typically, each employee (except those at the top of the organization chart) is a direct report of one or more managers, and may also have one or more alternate managers to whom the employee reports for work on specific projects.

Conducting performance reviews is an important function of the typical HR department of an employer entity or organization. A conventional performance review is typically an annual process in which individual employees are evaluated as to how well they have performed their work over the past year. Each employee's manager(s) typically provide narrative reviews of the employee's job performance over the past year, noting significant accomplishments and/or failures, and providing suggestions for ways to improve performance. Often, managers are asked to subjectively rate employees, e.g., on a scale from one to five, on characteristics such as “responsiveness” and “accountability,” bearing on the employees' ability to effectively and efficiently perform their jobs. Employees are also often asked to complete self-evaluations as part of the performance review process, subjectively rating their own job performance, and/or providing narrative reflections on their progress over the past year and/or on their plans for the upcoming year. These manager performance reviews and/or employee self-evaluations then typically become part of the employee's personnel file, and are used for reference in setting compensation levels, hiring for promotions, justifying terminations, etc.

Another function often performed by HR personnel is the task of succession planning. For particular employees in the employer's workforce, it may be important for HR personnel to be prepared with a list of other employees who could potentially succeed and replace the particular employee in case he/she one day gets promoted to another job or leaves the employer. HR personnel may engage in such succession planning for any employee in the workforce, although the process may be more important for employees who are particularly valuable to the employer. In the present disclosure, the set of other employees designated by HR personnel as potential successors for a particular employee is referred to as that employee's “succession pool” or “bench.”

### SUMMARY

One type of embodiment is directed to a method comprising: in a computer-implemented professional networking platform, providing an option for a first member of a professional community to designate a second member of the professional community as deserving of promotion; and in response to the first member designating the second member as deserving of promotion, receiving from the first member, via the computer-implemented professional networking platform, a nomination of a third member of the professional community as a potential successor for the second member.

Another type of embodiment is directed to at least one computer-readable storage medium encoded with computer-executable instructions that, when executed, perform a method comprising: in a computer-implemented professional networking platform, providing an option for a first member of a professional community to designate a second member of the professional community as deserving of promotion; and in response to the first member designating the second member as deserving of promotion, receiving from the first member, via the computer-implemented professional networking platform, a nomination of a third member of the professional community as a potential successor for the second member.

Another type of embodiment is directed to apparatus comprising at least one processor, and at least one storage medium storing instructions that, when executed by the at least one processor, cause the at least one processor to: provide an option, in a computer-implemented professional networking platform, for a first member of a professional community to designate a second member of the professional community as deserving of promotion; and in response to the first member designating the second member as deserving of promotion, receive from the first member of the professional community, via the computer-implemented professional networking platform, a nomination of a third member of the professional community as a potential successor for the second member.

Another type of embodiment is directed to a method comprising: receiving, from an employee, information about the employee's professional characteristics; applying, using at least one processor, one or more automated similarity algorithms to identify information likely to be of interest to the employee, based on the information about the employee's professional characteristics; providing to the employee the information likely to be of interest to the employee, in return for the information about the employee's professional characteristics; and presenting the information about the employee's professional characteristics to human resources (HR) personnel.

Another type of embodiment is directed to at least one computer-readable storage medium encoded with computer-executable instructions that, when executed, perform a method comprising: receiving, from an employee, information about the employee's professional characteristics; applying one or more automated similarity algorithms to identify information likely to be of interest to the employee, based on the information about the employee's professional characteristics; providing to the employee the information likely to be of interest to the employee, in return for the information about the employee's professional characteristics; and presenting the information about the employee's professional characteristics to human resources (HR) personnel.

Another type of embodiment is directed to apparatus comprising at least one processor, and at least one storage medium storing instructions that, when executed by the at least one processor, cause the at least one processor to: receive, from an employee, information about the employee's professional characteristics; apply one or more automated similarity algorithms to identify information likely to be of interest to the employee, based on the information about the employee's professional characteristics; provide to the employee the information likely to be of interest to the employee, in return for the information about the employee's professional characteristics; and present the information about the employee's professional characteristics to human resources (HR) personnel.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram illustrating an exemplary operating environment for a system in accordance with some embodiments of the present invention;

FIG. 2 illustrates an exemplary GUI that may be provided to collect profile information from an employee, in accordance with some embodiments of the present invention;

FIG. 3 illustrates an exemplary GUI that may be provided to present recommended information likely to be of interest to an employee, in accordance with some embodiments of the present invention;

FIG. 4 illustrates an exemplary way in which recommendations may be presented to an employee, in accordance with some embodiments of the present invention;

FIG. 5 illustrates an exemplary way in which an option may be provided for an employee to designate another employee as deserving of promotion, in accordance with some embodiments of the present invention;

FIG. 6 illustrates an exemplary GUI that may be provided in response to a user exercising an option to designate an employee as deserving of promotion, in accordance with some embodiments of the present invention;

FIG. 7 illustrates an exemplary GUI that may be provided to present nominations of potential successor pool members to a manager for review, in accordance with some embodiments of the present invention;

FIG. 8 illustrates an exemplary display that may be provided to present to managers and/or HR personnel a summary view of which employees currently need attention in the succession planning process, in accordance with some embodiments of the present invention;

FIG. 9 illustrates an exemplary display that may be provided to present to managers and/or HR personnel a summary view of which job categories and which employees currently need attention in the succession planning process, in accordance with some embodiments of the present invention;

FIG. 10 is a flowchart illustrating an exemplary method having applicability to succession planning, in accordance with some embodiments of the present invention;

FIG. 11 is a flowchart illustrating another exemplary method having applicability to succession planning, in accordance with some embodiments of the present invention; and

FIG. 12 is a block diagram illustrating an exemplary computer system on which aspects of the present invention may be implemented.

### DETAILED DESCRIPTION

The inventors have appreciated that the task of succession planning is often a challenging and inefficient one for HR personnel, especially because they often are not closely familiar with the people for whom they must create succession pools and the people from whom they must choose in creating those succession pools. For example, when creating a succession pool for a person having a certain set of skills, it may be important to identify potential candidates who have similar skills And when creating a succession pool for a person working in a particular geographic location, it may be important to identify potential candidates who either already work in that location or are willing to relocate there. However, HR personnel often do not have up-to-date information regarding such professional characteristics as the skills and relocation preferences of the people they must consider. Conventionally, information regarding such professional characteristics may be collected from an employee at the time that employee is hired, but rarely is the information updated throughout the course of employment. Annual performance reviews may include sections asking employees to provide updated information regarding their professional characteristics, but employees have little incentive to respond to these questions completely and accurately, especially when they are busy with other aspects of their jobs.

The inventors have recognized that HR personnel could have access to more complete, up-to-date and accurate information regarding the professional characteristics of employees if a positive incentive were provided to motivate employees to provide updated information during their employment. To that end, the inventors have developed an automated system that may prompt an employee for up-to-date information regarding his/her professional characteristics (referred to herein alternatively as “profile information”), and may use that information to automatically identify and recommend other information (e.g., regarding articles, training courses, discussion posts, collaboration groups, potential mentors, etc.) likely to be of interest to that employee. Although the information received about the employee's professional characteristics may also be forwarded to HR personnel, the inventors have appreciated that such a system may encourage employees to view the providing of updated profile information as a useful and personally beneficial way of finding out about information of interest to their professional development, rather than simply an onerous and intrusive extra task to do solely for the benefit of HR.

The inventors have also recognized that, whether or not employees provide up-to-date information about their professional characteristics to HR personnel, those HR personnel may not always be the best people to have sole input into the decisions of who should be in the succession pools for particular employees or other members of a professional community. The inventors have recognized that while HR personnel are often rather disconnected from the day-to-day activities and interactions of the rest of the professional community, in many cases it may be a person's coworkers who actually have the best idea who would be the best potential successors for that person, and even whether that person is a key member of the professional community (e.g., a top performer and/or deserving of promotion) for whom succession planning would be particularly warranted in the first place. The inventors have thus developed an automated system whereby non-HR members of a professional community may be encouraged to designate which of their coworkers are deserving of promotion, as well as which of their coworkers are potential successors for the ones so designated. Such nominations may be provided to HR personnel as crowd-sourced information to improve the accuracy and efficiency of succession planning.

Accordingly, some embodiments described herein relate to techniques having applicability to succession planning, which may address one or more of the above-discussed shortcomings of traditional methods, and/or that may provide one or more of the foregoing benefits. However, aspects of the invention are not limited to any of these benefits, and it should be appreciated that some embodiments may not provide any of the above-discussed benefits and/or may not address any of the above-discussed deficiencies that the inventors have recognized in conventional techniques.

In some embodiments, techniques described herein may be applied specifically to employees, as described above. In other embodiments, any of the techniques described herein with reference to employees may also be applied to any member of a professional community, including members who are not employees. As used herein, the term “professional community” refers to a set of people whose membership is defined and/or restricted based at least in part on the people's professional relationships with a set of one or more employers. For example, a professional community may include employees of an employer or group of employers, or a subset of employees of an employer or group of employers. In other examples, a professional community may not be limited solely to employees. For instance, a professional community could be formed to include one or more employers' employees or a subset of those employees, plus one or more non-employees having particular professional relationships with the one or more employers. For example, a professional community could be formed to include employees, customers, business partners, and/or the board of directors of an employer. It should be appreciated that this is merely an example, and that professional communities as referred to herein are not limited to any particular set of categories of people, but may include any suitable people having any suitable form of professional relationship with one or more employers. In some embodiments, a professional community may be defined by and/or coextensive with a set of people having access to an online network with limited membership, where the online network is provided by, maintained by, sponsored by and/or otherwise associated with a set of one or more employer entities. However, other embodiments may not require any particular relationship between a professional community and any particular online network, as aspects of the invention are not limited in this respect.

In some embodiments, a social network may be maintained whose membership is coextensive with the membership of the professional community, or whose membership includes a subset of the members of the professional community. Such a social network, all of whose members are members of the professional community, is referred to herein as being internal to the community. By contrast, a social network whose membership is not restricted to members of the professional community, including a social network whose membership is open to the general public, is referred to herein as being external to the community. As used herein, the term “social network” refers to a computerized platform allowing a plurality of online users to communicate and to post professional and/or personal information in an online “profile.” In some embodiments, a social network may be hosted as part of a computer-implemented talent management platform that maintains an online profile of professional and possibly personal information for each online user and provides tools for users to take actions related to career development and/or employer compliance online. As used herein, the term “professional networking platform” is generic to talent management platforms and social networks for professional communities.

In some embodiments, an option may be provided for a user (e.g., an employee or other member of a professional community) to designate a member of the professional community as deserving of promotion. The option may be provided in such a way as to make the user fully aware that the designation is of being deserving of promotion, or alternatively may be presented in a less specific way such that the user may designate a member as deserving of promotion without realizing that is the practical effect of exercising the option. For example, providing an option to endorse a member of a professional community as a “rock star” or other nonspecific appellation may cause the user to in effect designate the member as deserving of promotion without necessarily realizing that promotion is specifically being implicated. In some embodiments, in response to the user designating the member as deserving of promotion, the user may also be prompted or otherwise allowed to nominate one or more other members of the professional community as potential successor(s) for the member deserving of promotion. In some embodiments, the nomination(s) may be forwarded to HR personnel such that the HR personnel may include the nominee(s) in a succession pool in case the deserving member is in fact promoted at some point, or leaves the professional community or the employer. In some embodiments, the options to designate and nominate members may be provided via a professional networking platform, and in some embodiments, the designations and nominations may be received and presented to HR personnel via the professional networking platform. In some embodiments, any or all of these functions may be performed via a talent management platform and/or via a social network component of the talent management platform, as described in further detail below.

In some embodiments, information likely to be of interest to an employee may be provided to the employee in return for information about the employee's professional characteristics (“profile information”). The information likely to be of interest may be identified based on the profile information, once it is received from the employee, by applying one or more automated similarity algorithms. In some embodiments, the profile information may also be presented to HR personnel. In some embodiments, the employee may be prompted for the profile information, the information likely to be of interest may be presented to the employee, and/or the profile information may be presented to HR personnel via a professional networking platform, as described in further detail below.

It should be appreciated that the foregoing description is by way of example only, and aspects of the invention are not limited to providing any or all of the above-described functionality, although some embodiments may provide some or all of the functionality described herein.

The aspects of the present invention described herein can be implemented in any of numerous ways, and are not limited to any particular implementation techniques. Thus, while examples of specific implementation techniques are described below, it should be appreciate that the examples are provided merely for purposes of illustration, and that other implementations are possible.

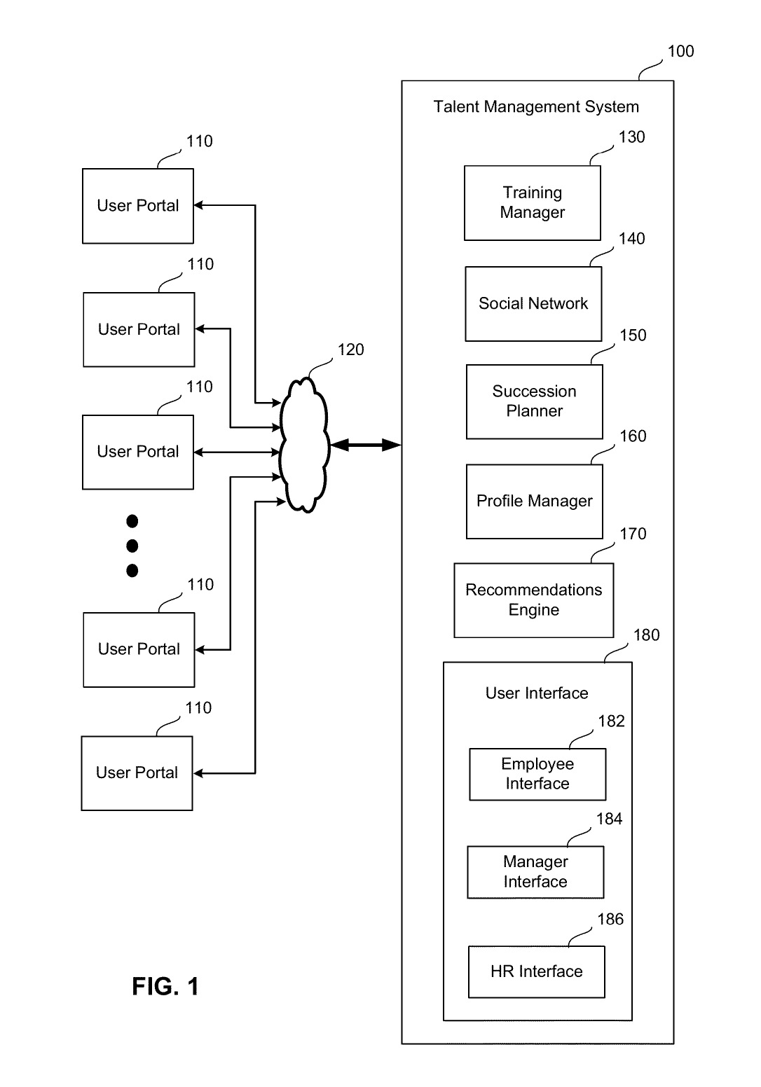

One illustrative application for the techniques described herein is for use in a system having applicability to succession planning. An exemplary operating environment for such a system is illustrated in FIG. 1. The exemplary operating environment includes a talent management system 100, which may be implemented in any suitable form, as aspects of the present invention are not limited in this respect. For example, system 100 may be implemented as a single stand-alone machine, or may be implemented by multiple distributed machines that share processing tasks in any suitable manner. System 100 may be implemented as one or more computers; an example of a suitable computer is described below. In some embodiments, system 100 may include one or more tangible, non-transitory computer-readable storage devices storing processor-executable instructions, and one or more processors that execute the processor-executable instructions to perform the functions described herein. The storage devices may be implemented as computer-readable storage media (i.e., tangible, non-transitory computer-readable media) encoded with the processor-executable instructions; examples of suitable computer-readable storage media are discussed below.

As depicted, system 100 includes training manager 130, social network component 140, succession planner 150, profile manager 160, recommendations engine 170 and user interface 180. Each of these processing components of system 100 may be implemented in software, hardware, or a combination of software and hardware. Components implemented in software may comprise sets of processor-executable instructions that may be executed by the one or more processors of system 100 to perform the functionality described herein. Each of training manager 130, social network component 140, succession planner 150, profile manager 160, recommendations engine 170 and user interface 180 may be implemented as a separate component of system 100 (e.g., implemented by hardware and/or software code that is independent and performs dedicated functions of the component), or any combination of these components may be integrated into a single component or a set of distributed components (e.g., hardware and/or software code that performs two or more of the functions described herein may be integrated, the performance of shared code may be distributed among two or more hardware modules, etc.). In addition, any one of training manager 130, social network component 140, succession planner 150, profile manager 160, recommendations engine 170 and user interface 180 may be implemented as a set of multiple software and/or hardware components. Although the example operating environment of FIG. 1 depicts training manager 130, social network component 140, succession planner 150, profile manager 160, recommendations engine 170 and user interface 180 implemented together on system 100, this is only an example; in other examples, any or all of the components may be implemented on one or more separate machines, or parts of any or all of the components may be implemented across multiple machines in a distributed fashion and/or in various combinations. It should be understood that any such component depicted in FIG. 1 is not limited to any particular software and/or hardware implementation and/or configuration.

In some embodiments, talent management system 100 may be accessible by one or more users via one or more user portals 110. User portals 110 may be implemented in any suitable manner, including as one or more computers and/or terminals, which may be local to and/or remote from system 100, as aspects of the present invention are not limited in this respect. User portals 110 may be connected to and/or may communicate with system 100 via any suitable connection(s), including wired and/or wireless connections. In the example depicted in FIG. 1, user portals 110 transmit data to and receive data from talent management system 100 through network 120. Network 120 may be any suitable network or combination of networks, including local and/or wide area networks, and may make use of any suitable wired and/or wireless connections. For example, network 120 may be a private network, such as a professional network accessible to members (e.g., employees, customers, partners, etc.) of a professional community having professional relationships with one or more employers, or a public network such as the Internet, or a combination of both types of networks.

In some embodiments, users within the professional community may use user portals 110 to access talent management system 100 via user interface 180, and talent management system 100 may in turn collect data regarding the users' use of the tools provided by talent management system 100. Users accessing user portals 110 may include any members of the professional community, and optionally any other people for whom access to talent management system 100 is considered appropriate. For simplicity, the further description of some embodiments hereinbelow refers to use of talent management system 100 by employees, e.g., of an employer represented by HR personnel. However, it should be appreciated, as discussed above, that in some embodiments, any reference to an “employee” hereinbelow may alternatively be replaced with a reference to a “member of a professional community.” While some embodiments may restrict the application of certain techniques described herein to employees, other embodiments may apply the same techniques to any members of a professional community, including non-employees.

When an employee user accesses talent management system 100 to access his/her own profile and/or to perform actions viewable to other members of the professional community and attributable to the user him/herself, the system may treat that user as a generic employee. When a user to whom one or more employees reports accesses talent management system 100 to engage in succession planning with respect to those other employees, the system may treat that user as a manager, provided the user has the required access authorization for that category of user. When a user accesses talent management system 100 to engage in succession planning with respect to the professional community (e.g., the employer's workforce) as a whole, or with respect to a subset of the professional community or workforce spanning multiple different manager groups, the system may treat that user as HR personnel, provided the user has the required access authorization for that category of user. It should be appreciated, however, that user categories such as “HR personnel,” “manager” and generic “employee” are merely examples, and other designations are possible. In some embodiments, a user's category such as “HR personnel” or “manager” with respect to system 100 may coincide with the user's job definition within the professional community. In some alternative embodiments, users may not be designated with predefined categories, but may instead have collections of any of various available access rights that determine what aspects of talent management system 100 they are authorized to use and/or configure.

In some embodiments, user interface 180 may be configured, e.g., through appropriate programming of one or more processors of talent management system 100, to provide data to and receive data from a user portal 110 in accordance with the access rights of the current user engaging that portal. For example, in some embodiments, user interface 180 may have different subcomponents for presenting employee interface 182, manager interface 184 and HR interface 186.

In some embodiments, functions enabled by employee interface 182 may be accessible to all employees, including HR personnel, managers and generic employees. Employee interface 182 may provide access, for example, to functions of talent management system 100 that allow the user to submit profile information, receive recommendations, designate other deserving employees, and/or nominate potential successors for those deserving employees, as described below.

In some embodiments, functions enabled by manager interface 184 may be accessible only to users who manage other employees and have access rights corresponding to the manager designation. Such functions may include, for example, the ability for the user to view and/or act upon potential successor nominations for employees in the manager's group, as described below. As used herein, the term “manager group” refers to the set of people including a manager and the employees who report to that manager. In some embodiments, managers may access functions enabled by manager interface 184 by logging in with credentials, such as user identifiers and/or passwords, that establish their access rights as managers.

In some embodiments, functions enabled by HR interface 186 may be accessible only to users (e.g., HR personnel) responsible for succession planning across the professional community or across sub-communities within the professional community that include multiple manager groups. Such functions may include, for example, the ability for the user to view and/or act upon potential successor nominations for employees across manager groups, and/or to view which employees provided the designations and/or nominations, as described below. In some embodiments, HR personnel may access functions enabled by HR interface 186 by logging in with credentials, such as user identifiers and/or passwords, that establish their access rights as HR personnel.

As discussed above, any employee, including a manager or HR personnel, can be considered a generic employee, and his/her succession pool can be managed using techniques described herein. In some embodiments, a person may be a generic employee, a manager and HR personnel, or any other combination thereof, simultaneously. Such a user may, for example, perform HR functions by accessing HR interface 186 (with the appropriate credentials), perform manager functions by accessing manager interface 184 (with the appropriate credentials), and access the user's own employee functions via employee interface 182. This is only an example, however, as aspects of the invention are not limited to any particular configuration for user interface 180. In some alternate embodiments, user interface 180 may not have separate components for employee, manager and HR interfaces, but may instead present a common interface with certain functions being disabled for users having inadequate access rights, or being visible only to users with appropriate access rights. Commonly, a professional community may need only a few HR personnel to attend to succession planning with respect to the professional community as a whole, and may have significantly larger numbers of managers and even larger numbers of generic employees. However, this is only an example, as aspects of the invention are not limited to any particular hierarchical structure for a professional community. In some embodiments, talent management system 100 may not treat users as generic employees, managers and HR personnel, but may regulate access rights in any suitable way, such as on an individual basis.

In some embodiments, employees may access talent management system 100, e.g., via network 120 and user interface 180, and may interact with components of talent management system 100 as part of their regular professional participation in the professional community (e.g., as part of their work for their employer). In some embodiments, these interactions may be monitored or otherwise aggregated and/or analyzed as part of collecting information regarding the employee's professional characteristics. Any suitable interactions with and/or actions performed via any suitable component(s) of talent management system 100 may be monitored and/or otherwise utilized in collecting such information, as aspects of the invention are not limited in this respect. However, some embodiments may provide for collecting information with reference to a member's use of particular components such as training manager 130, social network component 140, and/or profile manager 160, as described further below.

In some embodiments, training manager 130 may provide, e.g., through appropriate processing performed by one or more processors of talent management system 100, training and/or certification tools usable by members of the professional community. These may include, for example, online and/or paper-based training courses, seminars and/or webinars, tests and examinations, reference materials, and/or any other suitable training and/or certification tools. In some embodiments, use of some or all of these training tools may be required for some or all employees, e.g., as part of the employees' formal job requirements. For example, an employee whose job requires use of a particular software application may be required to complete a training course in the use of that software application, and an employee whose job requires compliance with a particular safety protocol may be required to complete an examination to gain formal certification in the knowledge of that safety protocol.

In some embodiments, training and/or certification requirements (hereafter referred to as “learning requirements”) may be assigned to an individual employee automatically based on his/her job title, job description, manager group affiliation, and/or any other suitable criteria. Such automatic assignment may be performed in any suitable way. For example, training manager 130 may be programmed to assign appropriate learning requirements to one or more employees based on current job information stored, e.g., in the employees' personal profiles by profile manager 160. In some embodiments, one or more administrators and/or HR personnel may specify which learning requirements apply to which job categories, and training manager 130 may then automatically apply the requirements as specified to employees across the professional community. Alternatively or additionally, managers may assign particular learning requirements to their manager groups, or to individual members of their manager groups. For example, if an individual employee has been involved in a negative safety incident, the employee's manager may decide to assign a safety training and/or re-certification requirement to that employee. In some embodiments, training manager 130 may be programmed to automatically assign individual learning requirements based on such triggering events and/or any other suitable criteria. Individual employees may be notified of their assigned learning requirements in any suitable way; for example, by notifications appearing on their personal profiles corresponding to data stored and/or maintained by profile manager 160.

In some embodiments, social network component 140 may provide, e.g., through appropriate processing performed by one or more processors of talent management system 100, infrastructure for running and/or maintaining a social network usable by members of the professional community. As discussed above, the social network may provide an online space for each member to build a unique profile containing professional and/or personal information. The social network may also provide the capability for members to link their profiles with the profiles of other members with whom they are acquainted, with whom they share a manager group and/or job title, and/or with whom they have any other suitable association. Such links may be represented, for example, by listing on a member's profile the names and/or other information of the other members to whom the member is linked, or in any other suitable way. Alternatively or additionally, the social network may provide the capability for a member to “follow” one or more other members, by receiving suitable notifications when the other members being followed post information to their profiles or to other spaces within the social network.

Items of information posted to a social network are referred to herein as “objects,” and may include free text, posts to blogs, discussion topics, links to electronic files, links to webpages, event postings, and/or any other item of information suitable for posting to a social network. In some embodiments, once an object has been contributed to a social network by being initially posted by a member, it may be shared with other targeted members within the social network. For instance, once a first member has contributed an object by posting it to the first member's profile, to a discussion board or to any other suitable space on the social network, a second member who notices the posted object may direct a third member to view the object (i.e., the second member may share the object with the third member). Such sharing may be accomplished in any suitable way—for instance, by allowing the second member, upon viewing the object, to send a message to the third member within the social network, containing a link to the object. In some embodiments, the social network may allow members to perform any of various actions on objects contributed to the social network, which may include viewing the object, sharing the object, rating the object, ranking the object, bookmarking the object, commenting on the object, and/or any other suitable action.

Alternatively or additionally, in some embodiments the social network may allow members to perform any of various actions on other members on the social network, which may include viewing a member's profile, sharing a member's profile, rating a member, ranking a member, bookmarking a member's profile, posting a comment or other object on another member's profile, providing an impression on a member, and/or any other suitable action. Providing an impression on another member may include posting to the social network a comment about a quality of the other member and/or about something the other member did, such as, “This person impressed me because she gave a great lecture yesterday,” or “This person is a great mentor.” It should be appreciated, however, that the foregoing are only examples, and any suitable social networking functions may be provided by one or more components of talent management system 100, such as social network component 140, as aspects of the invention are not limited in this respect.

In some embodiments, profile manager 160 may be configured to store and/or maintain, e.g., through appropriate processing performed by one or more processors of talent management system 100, unique profile information for individual members of the professional community. Such profile information may include, for example, basic biographical information about an employee and/or information about the employee's current and/or previous jobs, which may be entered by the employee, manager(s), administrator(s) and/or HR personnel upon hiring the employee, upon engaging the employee for a particular job, and/or at any other suitable time. In some embodiments, an employee may access profile manager 160, e.g., via user portal 110 and employee interface 182, to view and/or update information in his/her profile. In some embodiments, the employee's profile information may also be accessible to one or more managers, administrators and/or HR personnel, e.g., via user portal 110 and manager interface 184 and/or HR interface 186. In some embodiments, managers and/or HR personnel may have unlimited view and/or update access to employee profiles, while in other embodiments, managers and/or HR personnel may have any of various suitable combinations of predetermined and/or configurable access rights to profiles of other employees. In some embodiments, HR personnel may have view and/or update access to more employee profiles than managers; for example, in some embodiments, manager access rights may be limited to the profiles of employees within their own manager groups. Any suitable manager and/or HR personnel access rights to employee profiles may be implemented, as aspects of the invention are not limited in this respect.

In some embodiments, certain employees, managers and/or HR personnel may have access to view profile information of other employees, but not to update or otherwise change the information. In some embodiments, an employee's profile may be viewable by all members of the professional community, while in other embodiments, view access to an employee's profile may be limited in any suitable way, such as by job category, by manager group affiliation, and/or any other suitable criteria. In some embodiments, view and/or update access to an employee's profile may be configurable by the employee, manager(s) and/or HR personnel, such that certain other employees can be designated for view and/or update access to the employee's profile while others are not. In some embodiments, certain information within an employee's profile may be viewable and/or updatable by others while other information is not, and certain information may be viewable and/or updatable only by certain other employees. Such division of access rights to different information within an employee's profile may be set by default, configurable by the employee, manager(s), administrator(s) and/or HR personnel, and/or determined in any other suitable way. In some embodiments, an employee may have “public” profile information viewable by other members of the professional community, and different “private” profile information (which may overlap with the public information) viewable only to the employee, or only to the employee and limited other employees, such as managers and/or HR personnel. Alternatively or additionally, an employee's profile may have different (possibly overlapping) sets of non-public information viewable by different levels of managers and/or HR personnel. In some embodiments, an employee's profile may even contain information that is not accessible to the employee him/herself, but is only accessible to one or more managers and/or HR personnel. The foregoing are merely examples, however, as aspects of the invention are not limited to any particular implementation of access to profile information. Access rights may be configurable in any suitable way, such as by default programming and/or via case-by-case specification of access rights, e.g., by an administrator or other suitable personnel.

In some embodiments, an employee's profile information as stored and/or maintained by profile manager 160 may include information in the employee's online profile stored and/or maintained by social network component 140, and/or profile manager 160 may have access to online profile information managed by social network component 140. In some embodiments, profile information managed by profile manager 160 may be coextensive with online profile information available to the social network; while in other embodiments, some information may be managed by profile manager 160 that is not available to the social network, and/or some information may be managed by social network component 140 that is not managed by profile manager 160. In some embodiments, profile manager 160 may function to manage all of a member's profile information, and may make some or all of that information available to the social network. These and any other suitable implementations of profile management are possible, as aspects of the invention are not limited in this respect.

In some embodiments, profile manager 160 may store and/or maintain, in an employee's profile, information that may be used in succession planning and/or in providing recommendations to employees. Any suitable information regarding an employee's professional characteristics may be used, as aspects of the invention are not limited in this respect, although some embodiments provide for the consideration of particular items of profile information. Examples of suitable profile items, as described further below, include, but are not limited to, badges, certifications, educational degrees, group membership, job designations, language abilities, location, organization membership, relocation preferences, skills, and tags. It should be appreciated, however, that these are merely examples, and aspects of the invention are not limited to the inclusion of any of the foregoing items in profile information considered in succession planning and/or recommendations.

In some embodiments, recommendations engine 170 may be programmed to apply, e.g., through processing performed by one or more processors of talent management system 100, one or more similarity algorithms to information stored and/or maintained by profile manager 160, to generate one or more recommendations. For example, in some embodiments, profile information for a particular employee may be input to recommendations engine 170, which may apply one or more similarity algorithms to identify one or more other employees whose profile information is similar to that of the particular employee. In some embodiments, the identification of one or more similar employees may be passed to succession planner 150 for further use as described below. Alternatively or additionally, in some embodiments the identification of one or more similar employees may be used to identify information likely to be of interest to the particular employee, to be presented to the particular employee in return for providing profile information.

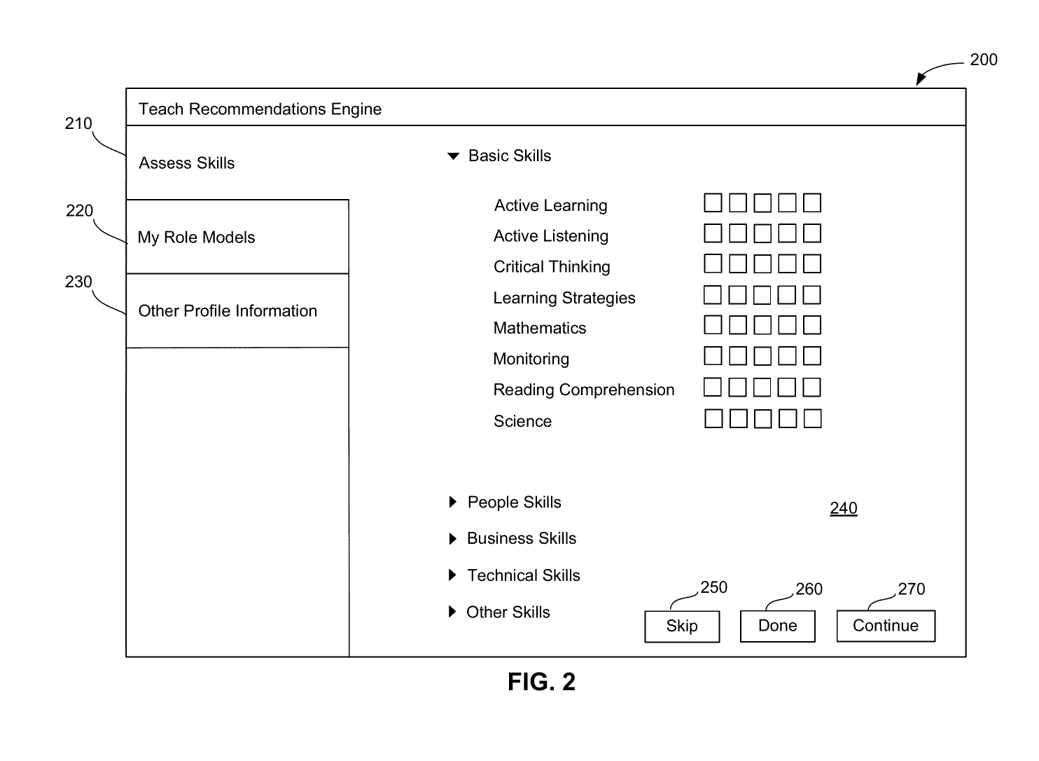

FIG. 2 illustrates an exemplary graphical user interface (GUI) 200 that may be provided in some embodiments to collect profile information (information about an employee's professional characteristics) from an employee. However, it should be appreciated that this is merely an example, as aspects of the present invention are not limited to any particular interface for collecting profile information. In the example of FIG. 2, GUI 200 invites the employee to teach the recommendations engine, reinforcing the idea that providing profile information is a useful step toward obtaining more relevant recommendations, and not just an annoying extra task requested by HR. Ideally, the more complete, accurate and up-to-date the profile information provided by the employee, the more likely the information recommended by the system in return will be of interest to the employee, so that the employee should be motivated to provide reliable information that will be useful to HR personnel.

As depicted in FIG. 2, exemplary GUI 200 contains an “Assess Skills” tab 210, a “My Role Models” tab 220, and an “Other Profile Information” tab 230. The display in area 240 varies depending on which tab is selected by the user. In FIG. 2, “Assess Skills” tab 210 is currently selected, and area 240 displays a number of skill categories in which the user is prompted to assess his/her skills. In this example, the “Basic Skills” category is currently open, and a number of skills within that category are available for the user to assess. For each skill, the user may select an available box to rate his/her skill level on a scale of 1 to 5. However, this is not required, as aspects of the invention are not limited to any particular manner of allowing an employee to provide information about his/her skills or skill levels, nor are aspects of the invention limited to any particular skills or skill categories about which to collect information.

In exemplary GUI 200, the user may select button 250 to skip over tab 210 without saving skill assessments, and to move on to the next tab 220. The user may select button 260 to save any assessed skills and exit GUI 200 without moving on to tab 220. The user may select button 270 to save any assessed skills and move on to the next tab and the next category of profile information to be collected. In exemplary GUI 200, the next category is “My Role Models” tab 220, in which the employee may be prompted to identify other members of the professional community whom the employee considers to be his/her role models. “Other Profile Information” tab 230 may prompt the employee to provide further information about the employee's professional characteristics not covered by the previous tabs. Non-limiting examples of suitable profile information to collect include information about the employee's certifications, educational degrees, job designations, language abilities, location, organization membership, and relocation preferences, among others. However, it should be appreciated that aspects of the invention are not limited to any particular set of profile information to be collected, nor are aspects of the invention limited to any particular information categories or tabs as depicted in exemplary GUI 200.

In some embodiments, once profile information has been received from the employee, recommendations engine 170 may apply one or more similarity algorithms to identify information likely to be of interest to the employee, based on his/her profile information. In some embodiments, the information likely to be of interest may be recommended to the employee in return for the employee providing profile information, e.g., via an interface such as GUI 200. In some embodiments, the recommendations may be made based only on profile information provided by the employee via such an interface, while in other embodiments, the profile information provided by the employee via such an interface may be aggregated with other profile information stored and/or maintained by profile manager 160, and recommendations may be made based on the total aggregated profile information.

In some embodiments, information likely to be of interest to the user may be identified by identifying one or more other employees having some connection to the user's profile information, and searching the other employees' profile information and/or activity on talent management system 100 for information likely to be of interest to the user. In some embodiments, one or more of the other employees may be directly identified by the user as one of the user's role models, e.g., via tab 220 of exemplary GUI 200. Alternatively or additionally, in some embodiments one or more of the other employees may be identified by matching the user's profile information with that of other employees. This may be done in any suitable way using any suitable technique(s) to identify one or more other employees having similar professional characteristics to the user, as aspects of the invention are not limited in this respect.

In one non-limiting example, a set of the user's professional characteristics may be compared with the corresponding set of professional characteristics of each other employee to compute a similarity measure for each other employee. Any suitable set of professional characteristics may be used, as aspects of the invention are not limited in this respect. Non-limiting examples of suitable professional characteristics may include:
Badges received by the employee and/or appearing on the employee's profile on the professional community's social network. A badge may be an icon or other visual item received in recognition of a particular accomplishment by an employee or a particular positive action performed by another employee on the employee's profile. Different badges may be awarded in recognition of different accomplishments and/or events. For example, an employee may receive a badge for completing a particular training course, and another badge for having a positive impression provided by another employee. In some embodiments, badges may be displayed on an employee's profile on the professional community's social network so that members can easily view each other's accomplishments.
Certifications achieved by the employee, such as a certification from a regulatory body that the employee is qualified to do a particular type of work.
Educational degrees obtained by the employee.
Membership of the employee in particular groups, such as manager groups, project groups, or ad hoc groups created by members on the professional community's social network.
Job category of the employee. In some embodiments, job categories may be created by the employer (e.g., by HR personnel or other administrators acting on the employer's behalf) as a way of categorizing employees based on the type of work they do. An example of an employer-specified job category might be “customer service level 3.”
Languages in which the employee has proficiency.
Location at which the employee currently works, and/or locations to which the employee would be willing to relocate.
Sub-organization within the employer's workforce to which the employee belongs. In some embodiments, sub-organizations may be defined by the employer (e.g., by HR personnel or other administrators acting on the employer's behalf) as a broader way of categorizing employees. An example of an employer-specified sub-organization might be “product management.”
Skills and/or skill levels possessed by the employee.
Keywords appearing on the employee's profile on the professional community's social network.

In one exemplary similarity algorithm, points may be assigned for each matching professional characteristic for a pair of employees, and/or a weight may be assigned to each professional characteristic to combine the points into a similarity score for the pair of employees. To identify other employees similar to the user, the similarity scores between the user and other employees may be ranked and thresholded, and the other employees having similarity scores above the threshold (or the top N most similar employees) may be identified. In some embodiments, the number of points assigned to different levels of match for each characteristic, the weights assigned to different characteristics, and/or the manner of thresholding similarity scores may be specified by the employer (e.g., by HR personnel or other administrators acting on the employer's behalf) in configuring recommendations engine 170. However, this is only an example, as aspects of the invention are not limited with respect to how or by whom recommendations engine 170 is configured.

Other non-limiting examples of suitable similarity algorithms include pattern matching algorithms, k-means clustering algorithms, fuzzy k-means clustering algorithms, Euclidean neighborhood algorithms, log-likelihood neighborhood algorithms, Pearson correlation neighborhood algorithms, CityBlock (/Manhattan) neighborhood algorithms, Tanimoto neighborhood algorithms, uncentered cosine neighborhood algorithms, and Spearman correlation neighborhood algorithms, among others.

In some embodiments, however one or more other employees having some connection to the user's profile information are identified (e.g., by direct identification as the user's role models, or by applying one or more similarity algorithms to identify other similar employees), recommendations engine 170 may search the other employees' profile information and/or activity on the professional community's social network to identify information to recommend to the user. For example, if the other employee has a skill that the user does not have, recommendations engine 170 may recommend that the user develop that skill as likely to enhance the user's skill set, and/or may recommend a training course designed to help the user develop that skill. In some embodiments, recommendations engine 170 may take into account HR preferences, such as by recommending skills and/or other professional characteristics that HR personnel have designated as being valuable for the user's job category. In another example, recommendations engine 170 may recommend information in which the other employee has shown interest, such as training courses the other employee has taken, posts the other employee has made, viewed, commented upon, etc., on the professional community's social network, groups to which the other employee belongs, etc. If the other employee is not already one of the user's role models or the user does not already follow the other employee on the professional community's social network, in some embodiments recommendations engine 170 may recommend that the user follow the other employee or consider the other employee a role model. However, these are only examples; it should be appreciated that aspects of the invention are not limited to any of the particular examples given above.

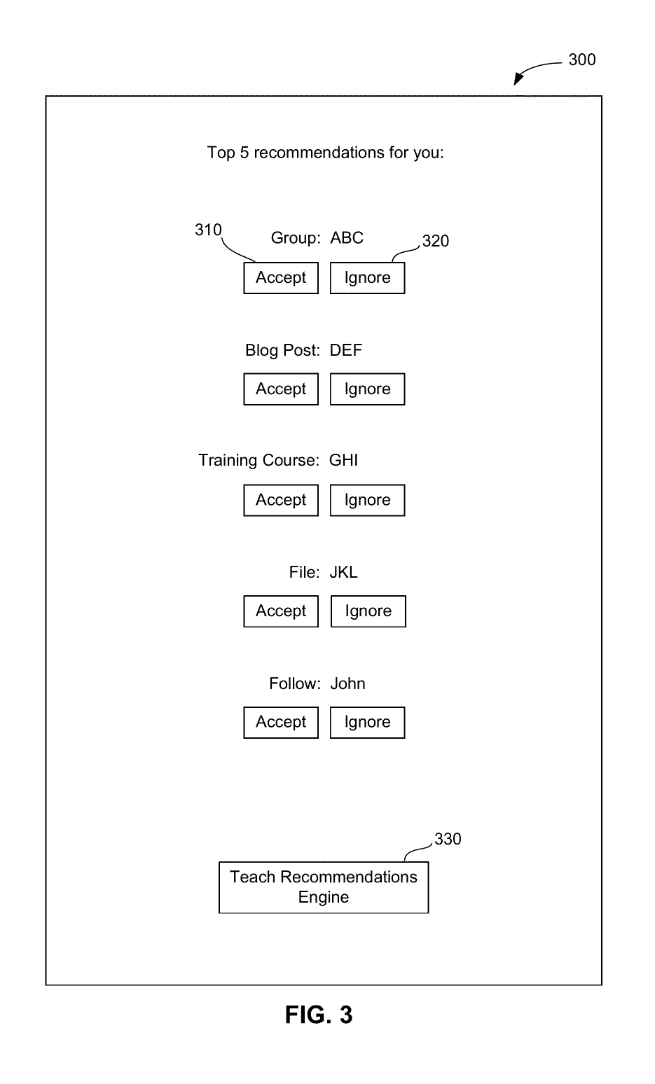

FIG. 3 illustrates an exemplary GUI 300 that may be provided in some embodiments to present recommended information likely to be of interest to an employee. However, it should be appreciated that this is merely an example, as aspects of the present invention are not limited to any particular interface for presenting recommendations. In the example of FIG. 3, GUI 300 presents the top 5 recommendations generated by recommendations engine 170, e.g., having the highest confidence level of being of interest to the employee. In this particular example, a group, a blog post, a training course, a file, and an other employee to follow are recommended to the user. For each recommendation, an option 310 is provided for the user to accept the recommendation (e.g., by joining the group, viewing the blog post or the file, enrolling in the training course, or following the other employee on the professional community's social network), and an option 320 is provided for the user alternatively to ignore the recommendation. Exemplary GUI 300 also provides an option 330 to return to GUI 200 and provide further profile information to “teach” recommendations engine 170 to make more accurate personalized recommendations with greater probability of being of interest to the user.

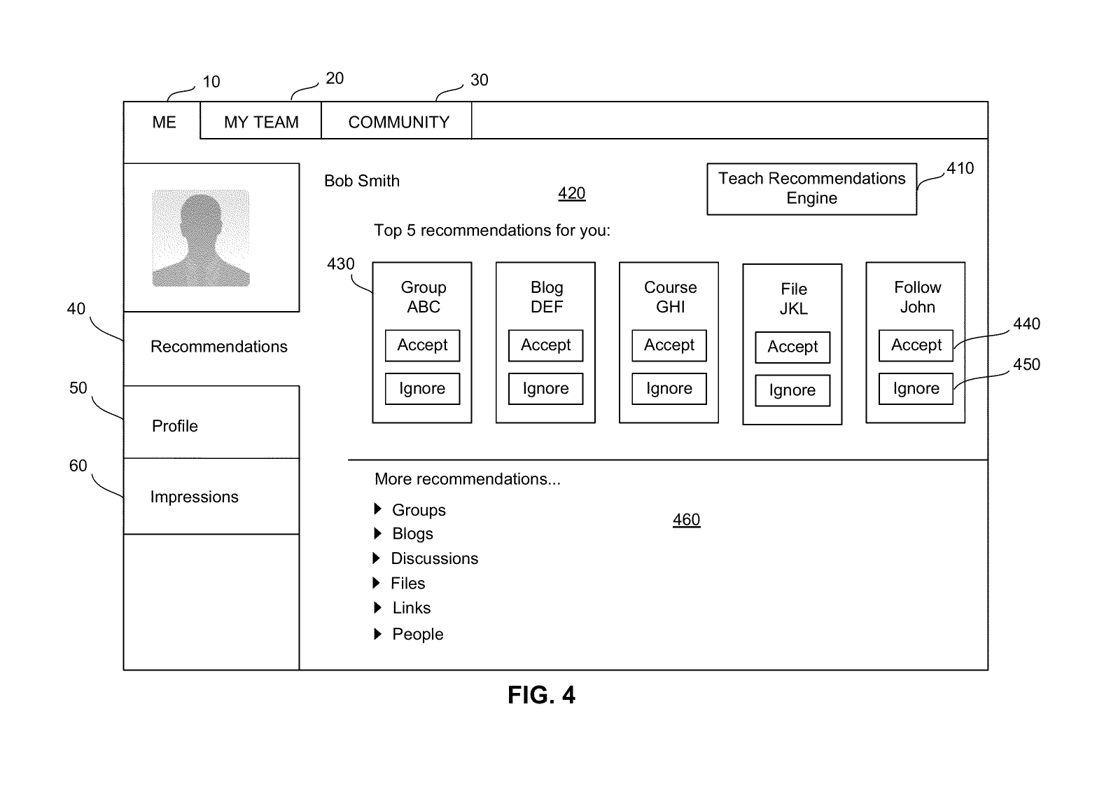

FIG. 4 illustrates another exemplary way in which recommendations may in some embodiments be presented to an employee, within the user's personal view on the professional community's social network. In the example of FIG. 4, the user's view includes “ME” tab 10, “MY TEAM” tab 20, and “COMMUNITY” tab 30. “ME” tab 10 is currently open for viewing information specific to the user himself, and includes “Recommendations” page 40, “Profile” page 50, and “Impressions” page 60. On “Recommendations” page 40, the user's top 5 recommendations are presented in area 420, each recommendation having a tile 430 with an option 440 to accept the recommendation, and an alternative option 450 to ignore the recommendation. Further recommendations (e.g., beyond the top 5) are presented in area 460, organized by type of information being recommended. “Recommendations” page 40 further includes an option 410 to return to GUI 200 and provide further profile information to “teach” recommendations engine 170. It should be appreciated, however, that FIG. 4 is merely one example, and aspects of the invention are not limited to any particular form of presentation of recommended information to an employee.

In some embodiments, information received from an employee about the employee's professional characteristics, for which information likely to be of interest to the employee is provided in return, may be presented to HR personnel, who may use the information, e.g., in succession planning. In some embodiments, employees who have been identified as role models by a number of other employees may automatically be identified as top performers for whom succession planning should be performed.

In some embodiments, succession planner 150 may be programmed to perform, e.g., through processing performed by one or more processors of talent management system 100, functions to aid employees, managers, HR personnel and/or other members of a professional community in succession planning. In some embodiments, succession planner 150 may be programmed to utilize and/or coordinate with other components of talent management system 100, such as social network component 140, profile manager 160, and/or recommendations engine 170, in performing these functions.

In some embodiments, as discussed above, information used in succession planning may be crowd-sourced by engaging non-manager employees in identifying top performers and their potential successors. In some embodiments, an option may be provided in a professional networking platform for a user to designate another employee (e.g., a coworker) as a top performer and therefore deserving of promotion. In some embodiments, the option may be provided via a talent management platform and/or via a social network of the professional community hosted by the talent management platform. Furthermore, in some embodiments, in response to the user designating the other employee as deserving of promotion, the system may receive from the user a nomination of one or more potential successors for the deserving employee. For example, in some embodiments, when a user designates one employee as deserving of promotion, the user may be prompted to nominate one or more other employees as potential successors for that employee.

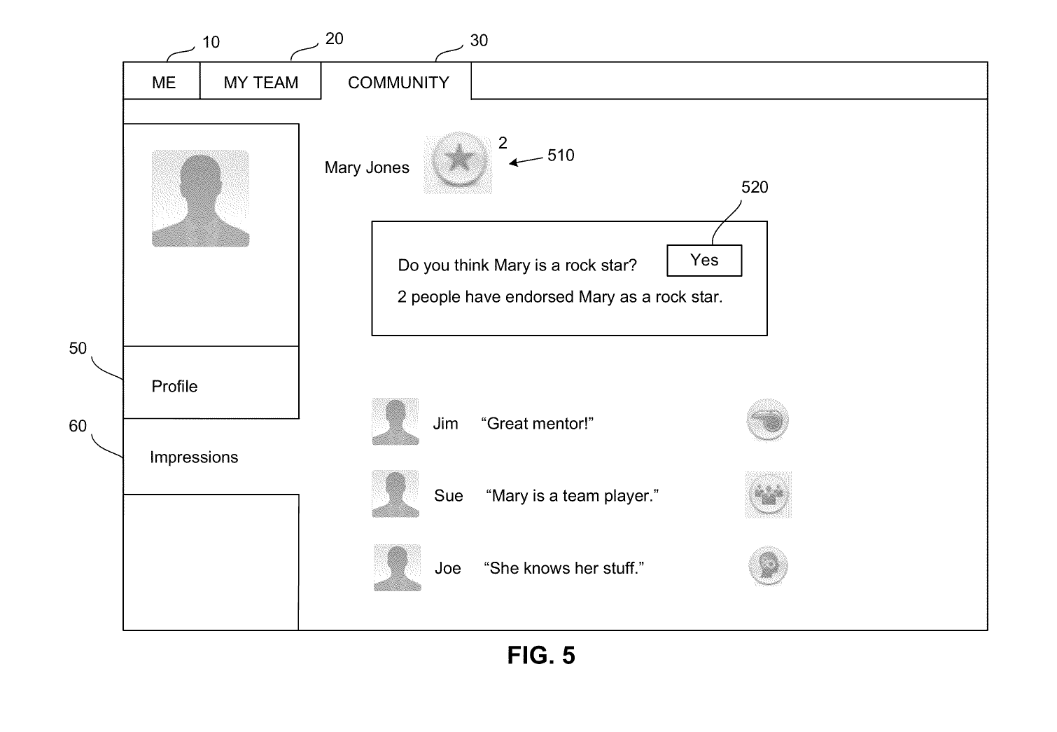

FIG. 5 illustrates an exemplary way in which an option may be provided for an employee to designate another employee as deserving of promotion, from the user's view of the other employee's space on the professional community's social network. In the example of FIG. 5, “COMMUNITY” tab 30 is currently open for the current user to view information specific to members of the professional community other than the user. The user has navigated to Mary Jones's space on the social network, and has opened “Impressions” page 60, on which impressions about Mary posted by other members of the professional community (Jim, Sue and Joe) are listed. In addition to the impressions, the page also informs the user that Mary has been endorsed as a “rock star” (i.e., as a top performer deserving of promotion) by two people. In some embodiments, when an employee is designated by another employee as deserving of promotion, the employee may receive a badge 510 in recognition of the designation. In the example of FIG. 5, “rock star” badge 510 is displayed on Mary's page on the professional community's social network. Mary's page further contains a prompt and an option 520 for the user currently viewing her page to designate her as a “rock star” deserving of promotion. However, this is merely an example, as aspects of the invention are not limited to any particular form of presentation of such an option to a member of a professional community. In another example, an employee may simply be prompted to designate one or more other employees as deserving of promotion via the professional networking platform, without first having navigated to their spaces on the professional community's social network.

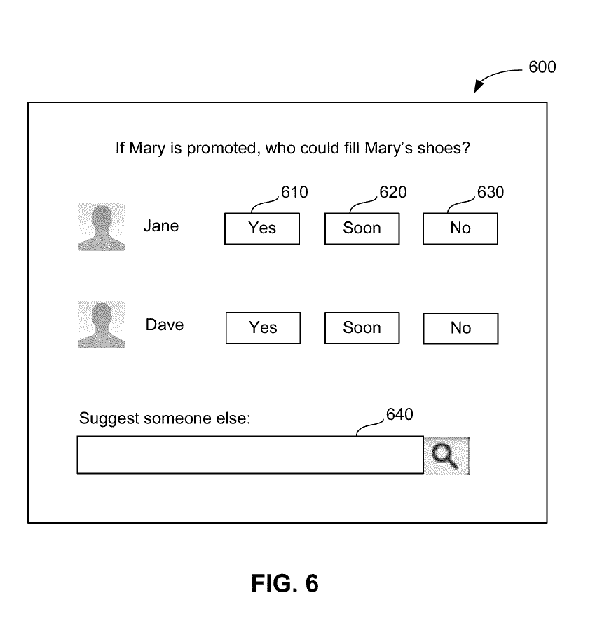

FIG. 6 illustrates an exemplary GUI 600 that may be provided in some embodiments in response to the user exercising the option to designate an employee (in this case, Mary) as deserving of promotion. In exemplary GUI 600, the user is prompted to nominate one or more other employees as potential successors for Mary. In some embodiments, one or more other employees (in this example, Jane and Dave) may be automatically identified and presented to the user as recommendations that the user could choose to nominate as potential successors for Mary. Exemplary GUI 600 provides an option 610 for the user to accept each automatic recommendation of a potential successor, an option 630 for the user to reject the automatic recommendation of a potential successor, and an option 620 for the user to indicate that the automatically recommended potential successor may one day be a good candidate to succeed the deserving employee, but is not ready yet. Exemplary GUI 600 also provides an option 640 for the user to suggest a potential successor who is not automatically recommended by the system. It should be understood, however, that the foregoing description and the illustration in FIG. 6 of GUI 600 are merely exemplary, as aspects of the invention are not limited to any particular interface for receiving nominations of one or more potential successors for an employee designated as deserving of promotion.

In some embodiments, to identify one or more other employees as automatic recommendations for potential successors for an employee designated as deserving of promotion, one or more similarity algorithms may be applied to identify other employees having similar characteristics to the employee designated as deserving. Any suitable similarity algorithm(s) may be used, as aspects of the invention are not limited in this respect. Non-limiting examples of suitable similarity algorithms are described above with respect to identifying similar employees for recommending information likely to be of interest to an employee. In some embodiments, the same similarity algorithm(s) may be used for both automatically recommending information likely to be of interest to an employee and automatically recommending potential successor(s) for an employee. However, in other embodiments, different similarity algorithms may be used, as aspects of the invention are not limited to the use of any particular similarity algorithm(s).

In some embodiments, a user's designation of an employee as deserving of promotion (or a sufficient number of users designating that employee as deserving) may cause that employee to be automatically included in a list of top performers for whom manager(s) and/or HR personnel should undertake succession planning. In some embodiments, a user's nomination of another employee as a potential successor for the deserving employee (or a sufficient number of users nominating that other employee as a potential successor) may cause that other employee to be automatically included in the succession pool for the deserving employee. In some embodiments, a user's nomination of another employee as a potential successor for the deserving employee (or a sufficient number of users nominating that other employee as a potential successor) may cause that other employee to be automatically included in the succession pool for a different employee having similar characteristics to the deserving employee, such as an employee having the same job category as the deserving employee. In some embodiments, the designated and nominated employees may be presented to managers and/or HR personnel as already automatically accepted as top performers and succession pool members, respectively. However, in other embodiments, the designations and nominations may first be presented to managers and/or HR personnel for review, and may be accepted or rejected by the reviewing user(s).

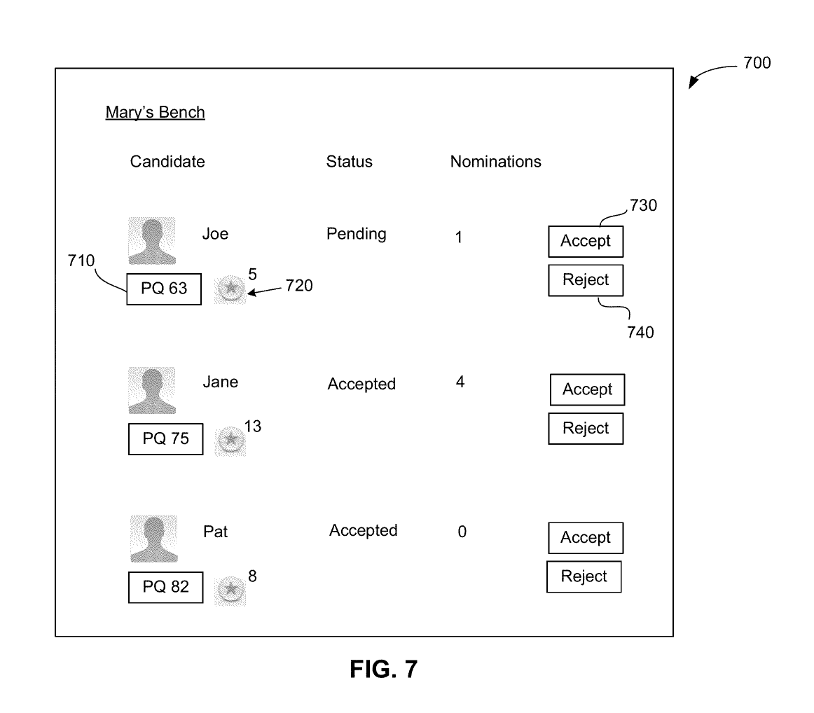

FIG. 7 illustrates an exemplary GUI 700 that may be provided in some embodiments to present nominations of potential successor pool members to a manager for review. In exemplary GUI 700, the manager user is presented with nominations submitted by other employees of employees who could be potential successors for Mary, a member of the manager's team (i.e., the manager group managed by that particular manager user). In this example, other employees have nominated Jane and Joe as potential successors for Mary. In addition, Pat has been identified directly by HR personnel as a potential successor for Mary, although Pat was not nominated by other employees. Exemplary GUI 700 displays, for each candidate, the number of nominations the candidate has received from other employees, and the candidate's status as accepted (e.g., by HR personnel) into Mary's succession pool (or “bench”) or pending review (i.e., not yet accepted or rejected). In exemplary GUI 700, candidates who have been rejected from the succession pool are not displayed; however, such rejected candidates could alternatively be displayed with status “Rejected.”

Exemplary GUI 700 provides, for each candidate, one or more summary metrics allowing the manager user to quickly perceive one or more aspects related to the quality of the candidate. For example, an evaluation score 710 is provided relating to the candidate's overall value to the professional community. Exemplary techniques for computing such an evaluation score are described in U.S. patent application Ser. No. 13/371,451, filed Feb. 12, 2012 and entitled “Methods and Apparatus for Evaluating Members of a Professional Community,” the disclosure of which is incorporated herein by reference in its entirety. As another example, an indication 720 of the number of “rock star” designations each candidate has received is also provided in exemplary GUI 700. For each candidate, exemplary GUI 700 also provides an option 730 to accept the nomination, as well as an alternative option 740 to reject the nomination.

In some embodiments, an interface provided to HR personnel to view an employee's bench may be similar to the view provided to the employee's manager, except that HR personnel may view candidates for employees across multiple manager groups, and may also be provided with an indication of which other employee provided each nomination of a candidate as a potential successor for the employee. In some embodiments, when a manager accepts a nomination via GUI 700, that action may be interpreted as the manager's own nomination of the candidate, and the manager may appear in the HR personnel's view of the employee's bench as the source of an additional nomination for that candidate. In some embodiments, when HR personnel exercises option 730 to accept a pending candidate, that candidate's status in GUI 700 may be updated to “Accepted,” and that candidate may be included in the succession pool for the employee. In some embodiments, when HR personnel exercises option 740 to reject a pending candidate, that candidate may be removed from the list of candidates for the employee's bench.

It should be appreciated, however, that the foregoing description and the exemplary GUI 700 depicted in FIG. 7 are merely examples, and aspects of the invention are not limited to any particular form of presentation of nominations to managers and/or HR personnel.

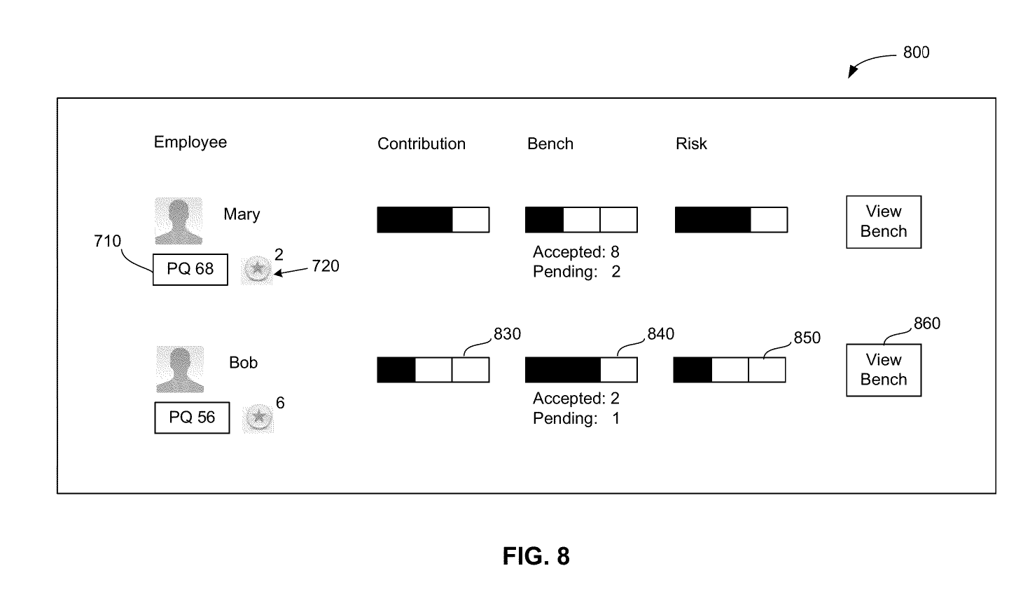

FIG. 8 illustrates an exemplary display 800 that may be provided in some embodiments to present to managers and/or HR personnel a summary view of which employees currently need attention in the succession planning process. For each employee, an option 860 is provided through which the user may navigate to exemplary GUI 700 to view that particular employee's detailed bench. In exemplary display 800, evaluation score 710, “rock star” designations 720, and contribution score 830 may allow the user (e.g., the manager or HR personnel) to quickly identify top performers for whom succession planning is most critical. In some embodiments, contribution score 830 may represent an overall assessment of the employee's contribution to the professional community, and may be computed in any suitable way. For example, contribution score 830 may take into account and combine suitable metrics such as performance review scores, number of designations as “rock star,” number of designations as “role model,” etc. However, these are merely examples, as aspects of the invention are not limited to any particular way of computing an overall contribution score.

In exemplary display 800, bench score 840 provides a visual assessment of the strength of an employee's succession pool, and may allow the user to quickly identify employees who do not have adequate succession pools, for whom extra effort to develop succession pools may be warranted. In some embodiments, bench score 840 may be directly proportional to the number of people currently accepted into the employee's succession pool. Additionally, exemplary display 800 provides risk score 850 as a visual assessment of the risk that an employee will leave his/her current position or leave the employer entirely. Risk score 850 may be computed in any suitable way. In some embodiments, risk score 850 may take into account and combine suitable metrics such as the employee's proximity to retirement age, whether the employee has indicated a desire to relocate, etc. However, these are merely examples, as aspects of the invention are not limited to any particular way of computing overall bench scores or risk scores.

In some embodiments, a display such as exemplary display 800 with suitable summary scores relevant to succession planning may allow a manager or HR personnel to quickly assess the most pressing current succession planning needs and allocate resources accordingly. For example, an employee with a high contribution score, high risk score, and low bench score may warrant swift and increased attention, as his/her position may be likely to be vacant soon, with a significant impact in terms of lost contribution to the community, and without sufficient potential successors identified to fill the void. However, it should be appreciated that the foregoing description is merely exemplary, and aspects of the invention are not limited to use of any particular summary scores or any particular form of presenting to managers and/or HR personnel summary views relevant to succession planning.

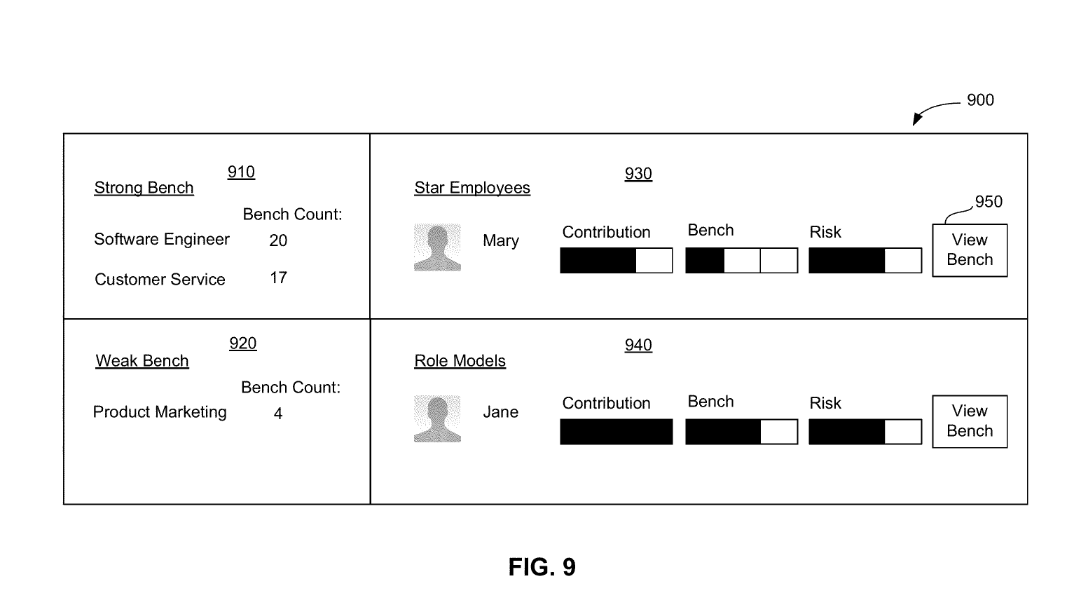

FIG. 9 illustrates an exemplary display 900 that may be provided in some embodiments to present to managers and/or HR personnel a summary view of which job categories and which employees currently need attention in the succession planning process. Exemplary display 900 provides a panel 910 in which the job categories currently having strong benches (as calculated by summing the number of employees accepted into the succession pools of employees currently employed in each job category) are listed, and a panel 920 in which the job categories currently having weak benches (with a low number of employees accepted into succession pools) are listed. Exemplary display 900 further provides a panel 930 listing Star Employees (e.g., employees designated by other employees as deserving of promotion, and/or identified directly by HR personnel as top performers) and their summary scores relevant to succession planning, as well as a panel 940 listing employees identified by other employees as their role models, along with their summary scores relevant to succession planning. For each employee listed in panels 930 and 940, an option 950 is provided for the user (e.g., the manager or HR personnel) to navigate to GUI 700 to view that employee's detailed bench. It should be appreciated, however, that aspects of the invention are not limited to use of exemplary display 900, nor to any particular form of exemplary display 900 or content displayed therein as depicted in FIG. 9.

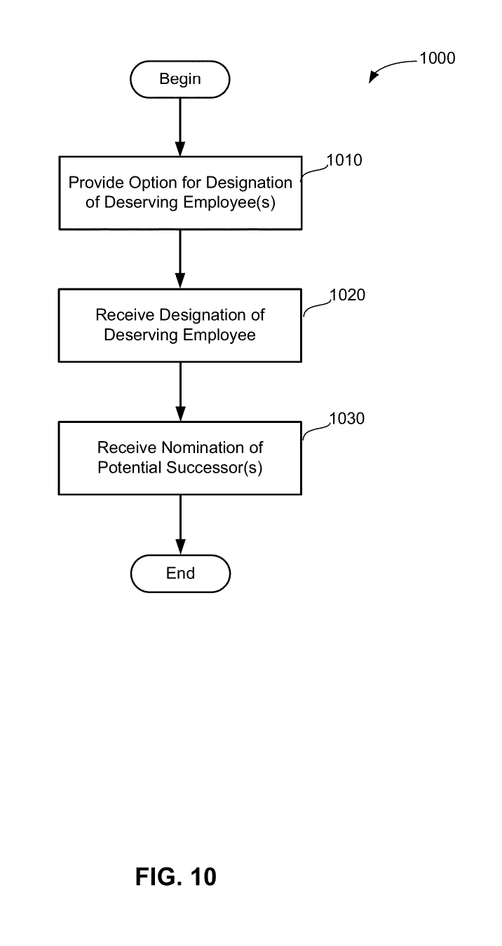

It should be appreciated from the foregoing that one embodiment of the invention is directed to a method 1000 having applicability to succession planning, as illustrated in FIG. 10. Method 1000 may be performed, for example, by one or more components of a talent management system 100 such as succession planner 150 and/or social network component 140, although other implementations are possible, as method 1000 is not limited in this respect. Method 1000 begins at act 1010, at which an option may be provided for a first employee (or a first member of a professional community) to designate a second employee (or a second member of the professional community) as deserving of promotion. As discussed above, in some embodiments such an option may be provided in a computer-implemented professional networking platform. At act 1020, the first employee's designation of the second employee as deserving of promotion may be received. At act 1030, in response to the first employee designating the second employee as deserving of promotion, a nomination may be received from the first employee, of a third employee (or a third member of the professional community) as a potential successor for the second employee. As discussed above, in some embodiments such a nomination may be received via the computer-implemented professional networking platform.

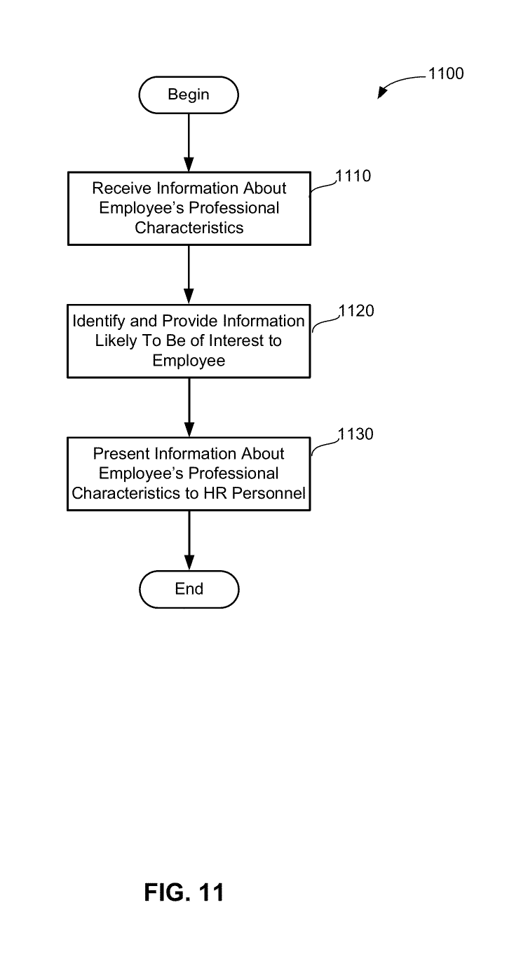

It should be appreciated from the foregoing that another embodiment of the invention is directed to another method 1100 having applicability to succession planning, as illustrated in FIG. 11. Method 1100 may be performed, for example, by one or more components of a talent management system 100 such as recommendations engine 170 and/or profile manager 160, although other implementations are possible, as method 1100 is not limited in this respect. Method 1100 begins at act 1110, at which information about an employee's professional characteristics may be received from the employee. At act 1120, information likely to be of interest to the employee may be identified and provided to the employee in return for the information about the employee's professional characteristics. As discussed above, in some embodiments, the information likely to be of interest to the employee may be identified based on the information about the employee's professional characteristics, by applying one or more automated similarity algorithms. At act 1130, the information about the employee's professional characteristics may also be presented to HR personnel.

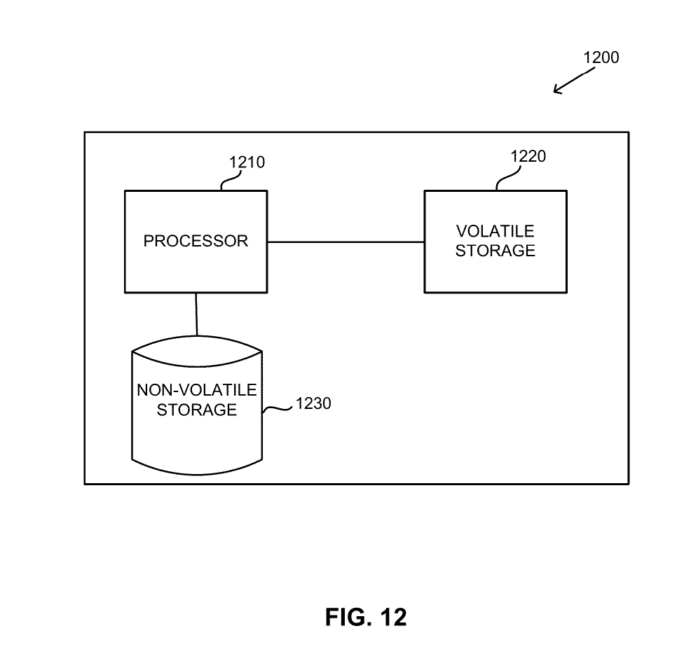

A system with applicability to succession planning in accordance with the techniques described herein may take any suitable form, as aspects of the present invention are not limited in this respect. An illustrative implementation of a computer system 1200 that may be used in connection with some embodiments of the present invention is shown in FIG. 12. One or more computer systems such as computer system 1200 may be used to implement any of the functionality described above. The computer system 1200 may include one or more processors 1210 and one or more computer-readable storage media (i.e., tangible, non-transitory computer-readable media), e.g., volatile storage 1220 and one or more non-volatile storage media 1230, which may be formed of any suitable non-volatile data storage media. The processor 1210 may control writing data to and reading data from the volatile storage 1220 and/or the non-volatile storage device 1230 in any suitable manner, as aspects of the present invention are not limited in this respect. To perform any of the functionality described herein, processor 1210 may execute one or more instructions stored in one or more computer-readable storage media (e.g., volatile storage 1220), which may serve as tangible, non-transitory computer-readable media storing instructions for execution by processor 1210.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of embodiments of the present invention comprises at least one computer-readable storage medium (i.e., at least one tangible, non-transitory computer-readable medium, e.g., a computer memory, a floppy disk, a compact disk, a magnetic tape, or other tangible, non-transitory computer-readable medium) encoded with a computer program (i.e., a plurality of instructions), which, when executed on one or more processors, performs above-discussed functions of embodiments of the present invention. The computer-readable storage medium can be transportable such that the program stored thereon can be loaded onto any computer resource to implement aspects of the present invention discussed herein. In addition, it should be appreciated that the reference to a computer program which, when executed, performs above-discussed functions, is not limited to an application program running on a host computer. Rather, the term “computer program” is used herein in a generic sense to reference any type of computer code (e.g., software or microcode) that can be employed to program one or more processors to implement above-discussed aspects of the present invention.

The phraseology and terminology used herein is for the purpose of description and should not be regarded as limiting. The use of “including,” “comprising,” “having,” “containing,” “involving,” and variations thereof, is meant to encompass the items listed thereafter and additional items. Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method comprising:
in a computer-implemented professional networking platform, providing an option for a first member of a professional community to designate a second member of the professional community as deserving of promotion; and
in response to the first member designating the second member as deserving of promotion, receiving from the first member, via the computer-implemented professional networking platform, a nomination of a third member of the professional community as a potential successor for the second member.

2. The method of claim 1, wherein the first member is not a manager of the second member.

3. The method of claim 1, wherein the first member is not a manager of the third member.

4. The method of claim 1, further comprising presenting to human resources (HR) personnel the nomination of the third member as a potential successor for the second member.

5. The method of claim 1, further comprising providing an indication, on a profile of the second member in the computer-implemented professional networking platform, that the second member was designated as deserving of promotion.

6. The method of claim 1, further comprising applying one or more automated similarity algorithms to identify a fourth member of the professional community, having similar characteristics to the third member, as a potential successor for the second member.

7. The method of claim 1, further comprising, in response to the nomination of the third member as a potential successor for the second member, including the third member in a succession pool for a fourth member of the professional community having similar characteristics to the second member.

8. At least one computer-readable storage medium encoded with computer-executable instructions that, when executed, perform a method comprising:
in a computer-implemented professional networking platform, providing an option for a first member of a professional community to designate a second member of the professional community as deserving of promotion; and
in response to the first member designating the second member as deserving of promotion, receiving from the first member, via the computer-implemented professional networking platform, a nomination of a third member of the professional community as a potential successor for the second member.

9. The at least one computer-readable storage medium of claim 8, wherein the first member is not a manager of the second member.

10. The at least one computer-readable storage medium of claim 8, wherein the first member is not a manager of the third member.

11. The at least one computer-readable storage medium of claim 8, wherein the method further comprises presenting to human resources (HR) personnel the nomination of the third member as a potential successor for the second member.

12. The at least one computer-readable storage medium of claim 8, wherein the method further comprises providing an indication, on a profile of the second member in the computer-implemented professional networking platform, that the second member was designated as deserving of promotion.

13. The at least one computer-readable storage medium of claim 8, wherein the method further comprises applying one or more automated similarity algorithms to identify a fourth member of the professional community, having similar characteristics to the third member, as a potential successor for the second member.

14. The at least one computer-readable storage medium of claim 8, wherein the method further comprises, in response to the nomination of the third member as a potential successor for the second member, including the third member in a succession pool for a fourth member of the professional community having similar characteristics to the second member.

15. Apparatus comprising:
at least one processor; and
at least one storage medium storing instructions that, when executed by the at least one processor, cause the at least one processor to:
provide an option, in a computer-implemented professional networking platform, for a first member of a professional community to designate a second member of the professional community as deserving of promotion; and
in response to the first member designating the second member as deserving of promotion, receive from the first member of the professional community, via the computer-implemented professional networking platform, a nomination of a third member of the professional community as a potential successor for the second member.

16. The apparatus of claim 15, wherein the first member is not a manager of the second employee or the third member.

17. The apparatus of claim 15, wherein the instructions further cause the at least one processor to present to human resources (HR) personnel the nomination of the third member as a potential successor for the second member.

18. The apparatus of claim 15, wherein the instructions further cause the at least one processor to provide an indication, on a profile of the second member in the computer-implemented professional networking platform, that the second member was designated as deserving of promotion.

19. The apparatus of claim 15, wherein the instructions further cause the at least one processor to apply one or more automated similarity algorithms to identify a fourth member of the professional community, having similar characteristics to the third member, as a potential successor for the second member.

20. The apparatus of claim 15, wherein the instructions further cause the at least one processor to, in response to the nomination of the third member as a potential successor for the second member, include the third member in a succession pool for a fourth member of the professional community having similar characteristics to the second member.
